(19) United States
(12) Patent Application Publication
(10) Pub. No.: US 2014/0161032 A1
(43) Pub. Date: Jun. 12, 2014

(54) COMMUNICATION DEVICES FOR MANAGING MULTIPLE OPERATION MODES OF A PLURALITY OF CO-LOCATED WIRELESS MODULES

(71) Applicant: Quanta Computer Inc., Kuei Shan Hsiang (TW)

(72) Inventor: Hsuan-Chih Chen, Kuei Shan Hsiang (TW)

(21) Appl. No.: 13/912,925

(22) Filed: Jun. 7, 2013

(30) Foreign Application Priority Data
Dec. 12, 2012 (TW) 101146803

(51) Int. Cl. H04W 40/12

(52) U.S. Cl. CPC H04W 40/12
USPC 370/328

(57) ABSTRACT

A communication device for managing multiple operation modes of a plurality of co-located wireless modules is provided. In the communication device, a first and second wireless module perform first and second wireless transceiving using first and second wireless technologies, respectively, and a managing module duplicates or fragments at least a Tx data packet according to the first wireless transceiving and the second wireless transceiving signal qualities, transmits the Tx data packet and the duplicated Tx data packet via the first wireless module and the second wireless module, respectively, or transmits the fragments of the Tx data packet via the first wireless module and the second wireless module, alternately, and aggregates a plurality of Rx data packets, which are received via the first wireless module and the second wireless module, according to the first wireless transceiving and the second wireless transceiving signal qualities.

### CROSS REFERENCE TO RELATED APPLICATIONS

This Application claims priority of Taiwan Patent Application No. 101146803, filed on Dec. 12, 2012, the entirety of which is incorporated by reference herein.

### BACKGROUND OF THE INVENTION

1. Field of the Invention

The invention generally relates to the operation management of wireless communications, and more particularly, to communication devices and methods for managing multiple operation modes of a plurality of co-located wireless modules, to improve transceiving rates and fault-tolerant rates thereof.

2. Description of the Related Art

With rapid developments in ubiquitous computing and networking, various wireless technologies have been developed, such as the Wireless Fidelity (WiFi) technology, Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, and Time- Division LTE (TD-LTE) technology, etc.

Due to the fact that different wireless technologies have different characteristics, such as bandwidths, average coverage, service rates, and costs, etc., having a plurality of wireless modules co-located in a single communication device has become a popular choice for providing convenience and flexibility for users. However, the co-located wireless modules generally operate independently in the activated/deactivated mode, in which wireless transceiving is performed separately by each wireless module. Thus, it is desirable to have a method for managing multiple operation modes of a plurality of co-located wireless modules within a single communication device, so as to coordinate wireless transceiving of the co-located wireless modules.

### BRIEF SUMMARY OF THE INVENTION

In one aspect of the invention, a communication device for managing multiple operation modes of a plurality of co-located wireless modules is provided. The communication device comprises a first wireless module, a second wireless module, and a managing module. The first wireless module is configured to perform first wireless transceiving using a first wireless technology. The second wireless module is configured to perform second wireless transceiving using a second wireless technology. The managing module is configured to duplicate or fragment at least a Transmission (Tx) data packet according to the first wireless transceiving and the second wireless transceiving signal qualities, and transmit the Tx data packet and the duplicated Tx data packet via the first wireless module and the second wireless module, respectively, or transmit the fragments of the Tx data packet via the first wireless module and the second wireless module, alternately. Also, the managing module is further configured to aggregate a plurality of Reception (Rx) data packets, which are received via the first wireless module and the second wireless module, according to the first wireless transceiving and the second wireless transceiving signal qualities.

In another aspect of the invention, a method for managing multiple operation modes of a first wireless module and a second wireless module is provided. The method comprises the steps of: duplicating or fragmenting at least a Tx data packet according to the first wireless transceiving and the second wireless transceiving signal qualities performed by the first wireless module and the second wireless module, transmitting the Tx data packet and the duplicated Tx data packet via the first wireless module and the second wireless module, respectively, or transmitting the fragments of the Tx data packet via the first wireless module and the second wireless module, alternately, and aggregating a plurality of Rx data packets, which are received via the first wireless module and the second wireless module, according to the first wireless transceiving and the second wireless transceiving signal qualities.

Other aspects and features of the invention will become apparent to those with ordinary skill in the art upon review of the following descriptions of specific embodiments of the communication devices and methods for managing multiple operation modes of a plurality of co-located wireless modules.

### BRIEF DESCRIPTION OF DRAWINGS

The invention can be more fully understood by reading the subsequent detailed description and examples with references made to the accompanying drawings, wherein:

FIG. 1 is a block diagram illustrating the system architecture of a communication device according to an embodiment of the invention;

FIG. 2 is a flow chart illustrating the method for managing multiple operation modes according to an embodiment of the invention;

FIG. 3 is a flow chart illustrating the determination of the operation mode according to an embodiment of the invention;

FIG. 4 is a flow chart illustrating a Tx operation of the first wireless module and the second wireless module according to an embodiment of the invention; and

FIG. 5 is a flow chart illustrating an Rx operation of the first wireless module and the second wireless module according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

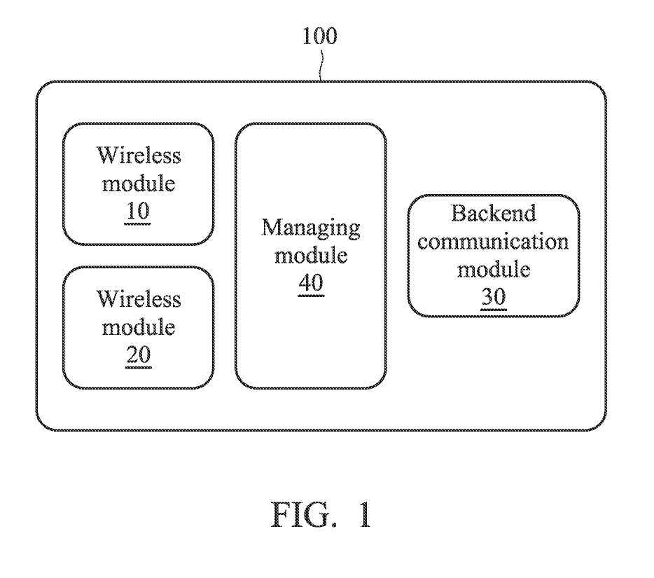

FIG. 1 is a block diagram illustrating the system architecture of a communication device according to an embodiment of the invention. The communication device 100 is capable of managing multiple operation modes of a plurality of co-located wireless modules. The communication device 100 may be a smart phone, tablet Personal Computer (PC), laptop computer (or called notebook), desktop computer, Access Point (AP), or any other devices capable of wireless communications. In the communication device 100, the wireless modules 10 and 20 are responsible for performing wireless transceiving using the same wireless technology or different wireless technologies. The backend communication module 30 is responsible for providing wired or wireless access to a backbone network (not shown), so that the communication device 100 may connect to the Internet via the backbone network. For example, the backend communication module 30 may use an Asymmetric Digital Subscriber Line (ADSL) to connect to the network of a certain Internet Service Provider (ISP). Alternatively, the backend communication module 30 may use the LTE technology to connect to the core network of an LTE network, thereby making the communication device 100 serve as a femto cell of the LTE network.

The managing module 40 is responsible for managing the operation mode of the wireless modules 10 and 20, and for processing the forwarding of data packets between the wireless modules 10 and 20, and the backend communication module 30. Specifically, the managing module 40 may be a processing unit, such as a general-purpose processor, an application processor, or a Micro-Control Unit (MCU), etc. Alternatively, the managing module 40 may be implemented as software/firmware code or machine code which, when executed by a processing unit, performs the managing of the operation mode of the wireless modules 10 and 20, and the processing of the forwarding of the data packets between the wireless modules 10 and 20, and the backend communication module 30.

To further clarify, each of the wireless modules 10 and 20 may comprise a baseband unit (not shown) and a Radio Frequency (RF) unit (not shown). The baseband unit may contain multiple hardware devices to perform baseband signal processing, including analog to digital conversion (ADC)/digital to analog conversion (DAC), gain adjusting, modulation/demodulation, encoding/decoding, and so on. The RF unit may receive RF wireless signals, convert the received RF wireless signals to baseband signals, which are processed by the baseband unit, or receive baseband signals from the baseband unit and convert the received baseband signals to RF wireless signals, which are later transmitted. The RF unit may also contain multiple hardware devices to perform radio frequency conversion. For example, the RF unit may comprise a mixer to multiply the baseband signals with a carrier oscillated in the radio frequency of the wireless communications system, wherein the radio frequency may be may be 2.4 GHz utilized by the WiFi technology, or may be 900 MHz, 2100 MHz, or 2.6 GHz utilized by the LTE technology, or others depending on the wireless technology in use. Although not shown, each of the wireless modules 10 and 20 may further connect to a respective antenna for transmission and reception of wireless signals.

In another embodiment, the communication device 100 may further comprise another backend communication module (not shown) which is responsible for providing wired access to the backbone network if the backend communication module 30 provides wireless access to the backbone network, or providing wireless access to the backbone network if the backend communication module 30 provides wired access to the backbone network. For example, the backend communication module 30 may use the ADSL or Ethernet to provide wired access to the backbone network, while another backend communication module (not shown) may use the LTE technology, WiMAX technology, or others to provide wireless access to the backbone network.

For ease of understanding, in a specific embodiment, the backend communication module 30 may use the ADSL to provide wired access to the backbone network, and the wireless modules 10 and 20 may be a WiFi module and an LTE module, respectively. That is, in this specific embodiment, the communication device 100 may be a WiFi AP incorporating the functionality of an LTE femto cell, but the invention is not limited thereto.

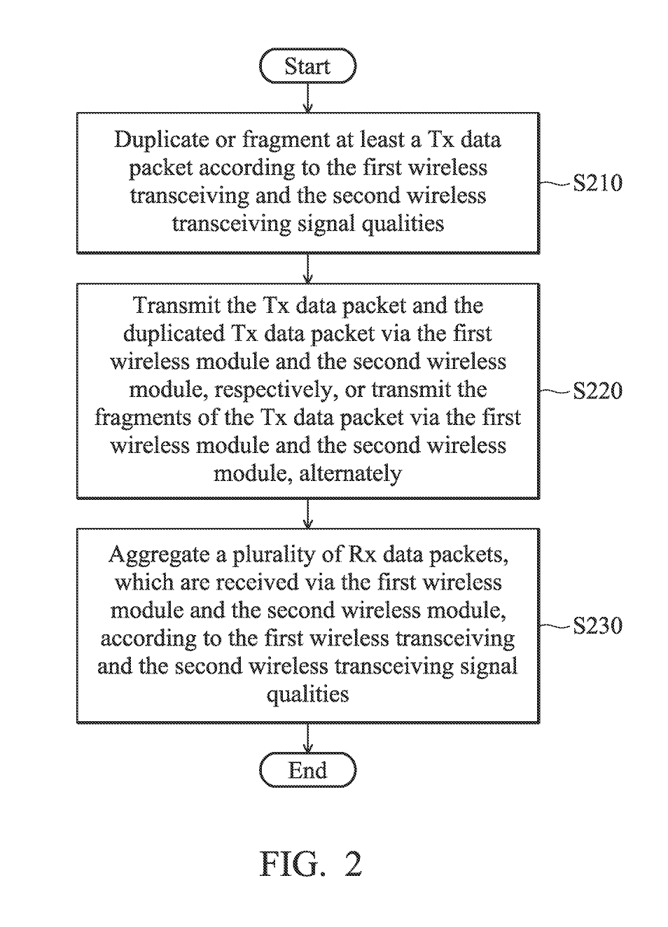

FIG. 2 is a flow chart illustrating the method for managing multiple operation modes according to an embodiment of the invention. In this invention, the method for managing multiple operation modes is applied for a communication device comprising a first wireless module and a second wireless module, such as the communication device 100. To begin, for a Transmission (Tx) operation, it is determined whether to duplicate or fragment at least a Tx data packet according to signal qualities of the wireless transceiving performed by the first and second wireless modules (i.e., wireless transceiving signal qualities of the first and second wireless modules) (step S210). Subsequently, the Tx data packet and the duplicated Tx data packet are transmitted via the first wireless module and the second wireless module, respectively, or the fragments of the Tx data packet are transmitted via the first wireless module and the second wireless module, alternately (step S220). After that, for a Reception (Rx) operation, a plurality of Rx data packets, which are received via the first wireless module and the second wireless module, are aggregated according to the signal qualities of the wireless transceiving performed by the first and second wireless modules (step S230).

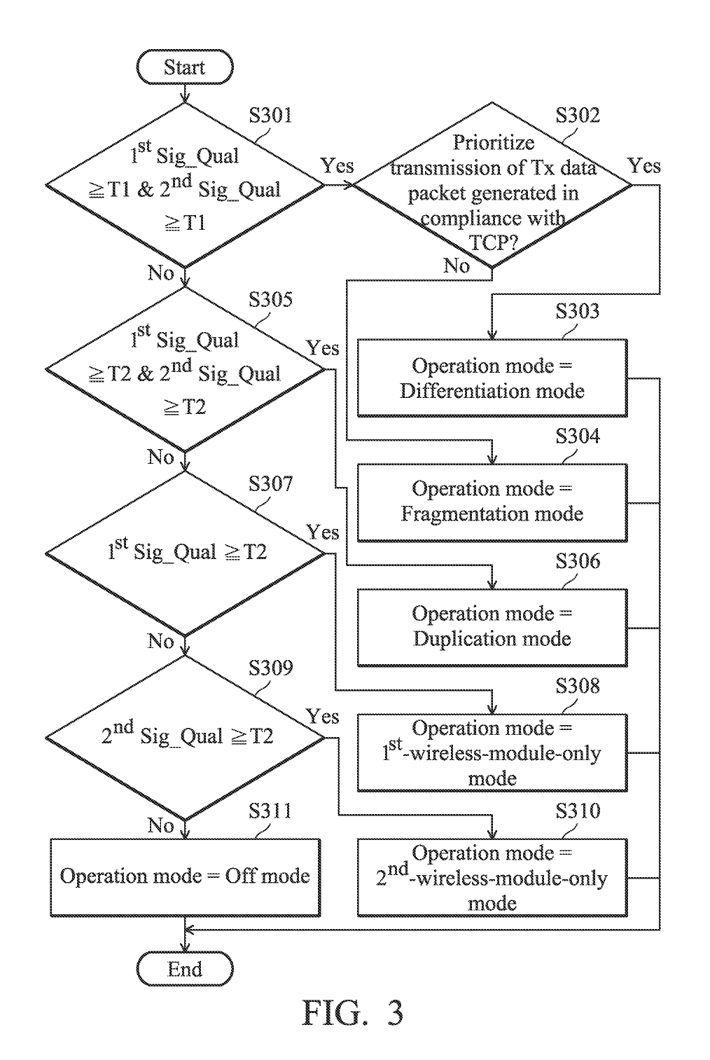

Detailed description regarding the steps S210 to S230 will be given below with respect to FIGS. 3 to 5.

Step S210 in FIG. 2 is performed for determining the operation mode of the first wireless module and the second wireless module. FIG. 3 is a flow chart illustrating the determination of the operation mode according to an embodiment of the invention. The determination of the operation mode is carried out according to the signal qualities of the wireless transceiving performed by the first wireless module and the second wireless module, and two thresholds for the signal qualities are predetermined for use in specifying whether the signal qualities are good or only average. To begin, it is determined whether both of the signal qualities of the wireless transceiving performed by the first wireless module and the second wireless module (denoted as 1^{st} Sig_Qual and 2^{nd} Sig_Qual in FIG. 3) are greater than the first threshold (denoted as T1 in FIG. 3) (step S310). If so, it means that both of the signal qualities are good, and then it is determined whether the transmission of the Tx data packet, which is generated in compliance with the Transmission Control Protocol (TCP), should be prioritized (step S302). Subsequent to the step S302, if so, the operation mode of the first wireless module and the second wireless module is configured to be a differentiation mode (step S303), and if not, the operation mode of the first wireless module and the second wireless module is configured to be a fragmentation mode (step S304). In one embodiment, a predetermined flag may be used to specify whether the transmission of the Tx data packet, which is generated in compliance with the TCP, should be prioritized.

Subsequent to the step S301, if not, it is determined whether both of the signal qualities of the wireless transceiving performed by the first wireless module and the second wireless module are greater than the second threshold (denoted as T2 in FIG. 3) (step S305). Please note that the second threshold is less than the first threshold. If both of the signal qualities are greater than the second threshold, it means that the signal qualities are only average, and the operation mode of the first wireless module and the second wireless module is configured to be a duplication mode (step S306).

Subsequent to the step S305, if not, it is determined whether the signal quality of the wireless transceiving performed by the first wireless module is greater than the second threshold (step S307). If the signal quality of the wireless transceiving performed by the first wireless module is greater than the second threshold, it means that only the first wireless module can provide qualified wireless services, so the operation mode of the first wireless module and the second wireless module is configured to be a 1^{st}-wireless-module-only mode (step S308).

Subsequent to the step S307, if not, it is determined whether the signal quality of the wireless transceiving performed by the second wireless module is greater than the second threshold (step S309). If the signal quality of the wireless transceiving performed by the second wireless module is greater than the second threshold, it means that only the second wireless module can provide qualified wireless services, so the operation mode of the first wireless module and the second wireless module is configured to be a 2^{nd}-wireless-module-only mode (step S310).

Subsequent to the step S309, if not, it means that none of the first wireless module and the second wireless module can provide qualified wireless services, and the operation mode of the first wireless module and the second wireless module is configured to be an off mode (step S311).

In another embodiment, another predetermined flag may be used to specify whether the communication device is mobile or immobile. If the flag specifies that the communication device is immobile, the determination of the operation mode in FIG. 3 may be performed only once after the communication device is powered on. Otherwise, if the flag specifies that the communication device is mobile, a further determining step may be performed to see if the communication device is being moved according to the signal qualities of the wireless transceiving performed by the first wireless module and the second wireless module, and if so, the determination of the operation mode in FIG. 3 may be repeated. Specifically, the communication device may periodically detect whether the signal qualities of the wireless transceiving performed by the first wireless module and the second wireless module have changed, to determine whether it is being moved or not. In a preferred embodiment, one of the first wireless module and the second wireless module, which uses the Wide Area Network (WAN) technology (e.g., the WiMAX or LTE technology) for wireless transceiving, may be selected to detect the change of its signal quality, and accordingly determine whether the communication device is being moved or not.

The above-described signal qualities may be determined based on Received Signal Strength Indication (RSSI), Signal to Noise Ratio (SNR), Adjacent Channel Interference (ACI), Packet Error Rate (PER), or Bit Error Rate (BER). When a signal quality is only average, it means that the signal quality is only enough for connection establishment, but if signal interference increases, the established connection may be affected, or worse, the connection establishment may not be successful. When a signal quality is good, it means that the signal quality is more than enough for connection establishment and the established connection may tolerate possible signal interference.

For ease of understanding, Table 1 below shows the mapping relationship between different operation modes and the first and second wireless modules.

TABLE 1

| First wireless | Second wireless | |
|---|---|---|
| module | module | Operation mode |
| OFF | OFF | Off mode |
| (signal quality | (signal quality | |
| below average) | below average) | |
| OFF | ON | 2^{nd}-wireless- |
| (signal quality | (signal quality | module-only mode |
| below average) | above average) | |
| ON | OFF | 1^{st}-wireless- |
| (signal quality | (signal quality | module-only mode |
| above average) | below average) | |
| ON | ON | Duplication |
| (signal quality | (signal quality | mode |
| above average) | above average) | |
| ON | ON | Fragmentation |
| (signal quality | (signal quality | mode |
| above average) | above average) | |
| ON | ON | Differentiation |
| (signal quality | (signal quality | mode |
| above average) | above average) | |

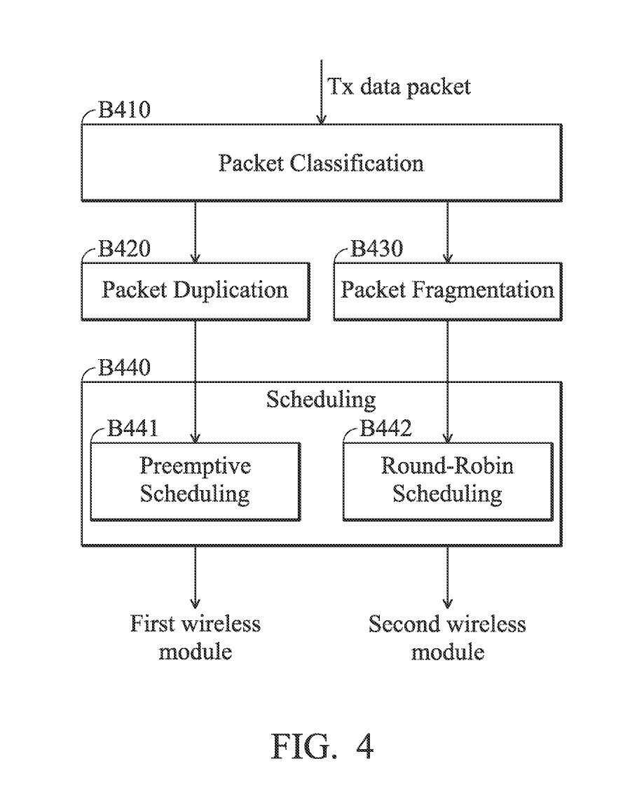

Step S220 in FIG. 2 mainly describes the Tx operation of the first wireless module and the second wireless module in the differentiation mode, fragmentation mode, and duplication mode. FIG. 4 is a flow chart illustrating a Tx operation of the first wireless module and the second wireless module according to an embodiment of the invention. In FIG. 4, each process is represented by a respective block. To begin, at Block B410, the Tx data packet is classified according to the operation mode of the first wireless module and the second wireless module, and according to whether the Tx data packet is generated in compliance with the TCP. If the operation mode is the duplication mode, Block B420 is performed. If the operation mode is the differentiation mode and the Tx data packet is generated in compliance with the TCP, Block B420 is performed. If the operation mode is the fragmentation mode, Block B430 is performed. If the operation mode is the differentiation mode and the Tx data packet is not generated in compliance with the TCP, Block B430 is performed. At Block B420, the Tx data packet is duplicated. At Block B430, the Tx data packet is fragmented. After the Tx data packet is duplicated or fragmented, Block B440 is performed. Particularly, the Tx data packet and the duplicated Tx data packet are forwarded to Sub-Block B441, and the fragments of the Tx data packets are forwarded to Sub-Block B442.

At Sub-Block 441, it is determined whether to use preemptive scheduling for transmitting the Tx data packet and the duplicated Tx data packet via the first wireless module and the second wireless module, respectively. Specifically, when the operation mode is the differentiation mode, preemptive scheduling is used for the transmission of the Tx data packet and the duplicated Tx data packet. That is, the ongoing Tx operations of the first wireless module and the second wireless module must be suspended, and the transmission of the Tx data packet and the duplicated Tx data packet should be prioritized. If the operation mode is the duplication mode, non-preemptive scheduling is used for the transmission of the Tx data packet and the duplicated Tx data packet. That is, the transmission of the Tx data packet and the duplicated Tx data packet must be performed after the ongoing Tx operations of the first wireless module and the second wireless module.

At Sub-Block B442, round-robin scheduling is used for transmitting the fragments of the Tx data packet via the first wireless module and the second wireless module, alternately. In another embodiment for Sub-Block B442, weighted round-robin scheduling may be used instead. To further clarify the case where weighted round-robin scheduling is used, assuming that the transceiving rate or bandwidth is used as the weighting factor, if the ratio of transceiving rate or bandwidth of the first wireless module and the second wireless module equals to A:B, then a number of A fragments of the Tx data packet are transmitted via the first wireless module and a number of B fragments of the Tx data packet are transmitted via the second wireless module, and so on, until all fragments have been transmitted.

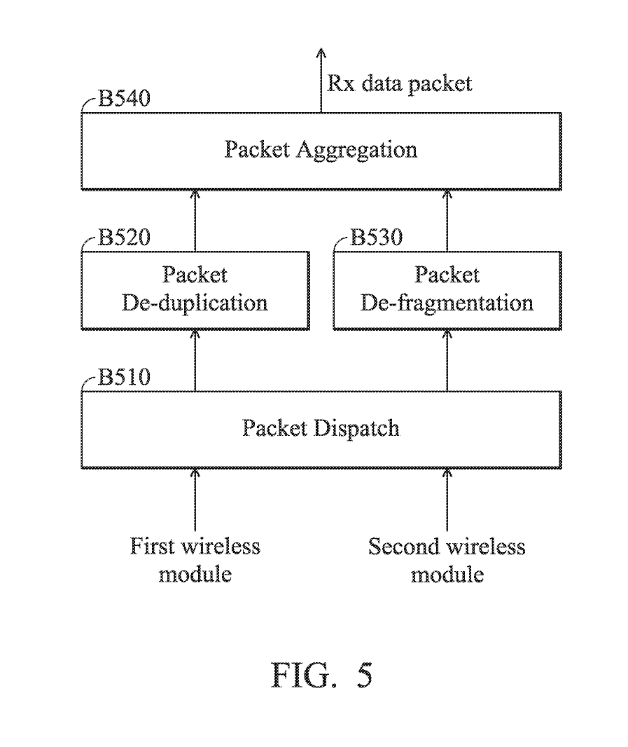

The step S230 in FIG. 2 mainly describes an Rx operation of the first wireless module and the second wireless module in the differentiation mode, fragmentation mode, and duplication mode. FIG. 5 is a flow chart illustrating an Rx operation of the first wireless module and the second wireless module according to an embodiment of the invention. To begin, at Block B510, the Rx data packet received via the first wireless module and the second wireless module are dispatched. Specifically, it is determined whether the Rx data packet is a complete data packet or only a fragment of some data packet, and if it is a complete data packet, Block B520 is performed. Otherwise, if it is only a fragment of some data packet, Block B530 is performed.

At Block B520, de-duplication of the Rx data packet is performed. Specifically, the de-duplication involves performing Cycle Redundancy Check (CRC) on the Rx data packet or its duplicate, and forwarding one of them which has passed the CRC to Block B540.

At Block B530, de-fragmentation of the Rx data packet is performed. That is, the fragments of a data packet are concatenated. After that, at Block B540, aggregation of the Rx data packet is performed. Specifically, the aggregation is performed for the case where the receiving of fragments of an Rx data packet has been interrupted by a Tx data packet transmission with the preemptive scheduling. For example, during the receiving of fragments of an Rx data packet which is fragmented into 4 pieces, the first wireless module and the second wireless module are interrupted by a Tx data packet transmission using the preemptive scheduling when only 3 fragments of the Rx data packet are received. As a result, only 3 fragments of the Rx data packet are concatenated at Block B530, and at Block B540, it is determined that the de-fragmentation of the Rx data packet is not yet completed and the de-fragmentation will wait until the fourth fragment is received, or the retransmission of the fourth fragment is requested when it is not received after waiting for a predetermined period of time.

It is to be understood that, unlike the conventional design (in which wireless transceiving of each wireless module is performed independently), the method for managing multiple operation modes in this invention coordinates a plurality of co-located wireless modules for performing wireless transceiving, so as to improve transceiving rate and fault-tolerant rate. Specifically, when the first wireless module and the second wireless module operate in the duplication mode, the fault-tolerant rate, i.e., the transmission reliability, is improved because of that the same Tx data packet is simultaneously transmitted via the first wireless module and the second wireless module. When the first wireless module and the second wireless module operate in the fragmentation mode, the transceiving rate is improved because of that a Tx data packet is fragmented and the fragments are transmitted via the first wireless module and the second wireless module, alternately. In addition, when the first wireless module and the second wireless module operate in the differentiation mode, both of the transceiving rate and the fault-tolerant rate are improved because of that duplication or fragmentation of a Tx data packet is performed according to the protocol type used for generation of the Tx data packet. That is, for the Tx data packet which is generated in compliance with the TCP, the Tx data packet is duplicated for transmission to improve the fault-tolerant rate. For the Tx data packet which is not generated in compliance with the TCP, the Tx data packet is fragmented for transmission to improve the transceiving rate.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. A communication device for managing multiple operation modes of a plurality of co-located wireless modules, comprising:
a first wireless module, configured to perform first wireless transceiving using a first wireless technology;
a second wireless module, configured to perform second wireless transceiving using a second wireless technology; and
a managing module, configured to duplicate or fragment at least a Transmission (Tx) data packet according to the first wireless transceiving and the second wireless transceiving signal qualities, transmit the Tx data packet and the duplicated Tx data packet via the first wireless module and the second wireless module, respectively, or transmit the fragments of the Tx data packet via the first wireless module and the second wireless module, alternately, and aggregate a plurality of Reception (Rx) data packets, which are received via the first wireless module and the second wireless module, according to the first wireless transceiving and the second wireless transceiving signal qualities.

2. The communication device of claim 1, wherein the managing module is further configured to determine whether the Tx data packet is generated in compliance with a Transmission Control Protocol (TCP), when both of the first wireless transceiving and the second wireless transceiving signal qualities are greater than a first threshold.

3. The communication device of claim 2, wherein if the Tx data packet is generated in compliance with the TCP, the managing module is further configured to perform the duplication of the Tx data packet, and have one of the Rx data packets passing a Cycle Redundancy Check (CRC) as a result of the aggregation of the Rx data packets.

4. The communication device of claim 3, wherein the managing module is further configured to instruct the first wireless module and the second wireless module to prioritize the transmission of the Tx data packet which is generated in compliance with the TCP.

5. The communication device of claim 2, wherein if the Tx data packet is not generated in compliance with the TCP, the managing module is further configured to perform the fragmentation of the Tx data packet, and concatenate the Rx data packets to obtain a result of the aggregation of the Rx data packets.

6. The communication device of claim 5, wherein the managing module is further configured to instruct the first wireless module and the second wireless module to alternately transmit the fragments of the Tx data packet.

7. The communication device of claim 2, wherein when both of the first wireless transceiving and the second wireless transceiving signal qualities are less than the first threshold and greater than a second threshold, the managing module is further configured to perform the duplication of the Tx data packet, and have one of the Rx data packets passing a Cycle Redundancy Check (CRC) as a result of the aggregation of the Rx data packets.

8. The communication device of claim 1, wherein the managing module is further configured to determine whether the communication device is being moved according to the first wireless transceiving and the second wireless transceiving signal qualities, and if the communication device is being moved, repeat the duplication or fragmentation of the Tx data packet and the aggregation of the Rx data packets.
